(19) United States
(12) Patent Application Publication
(10) Pub. No.: US 2015/0112810 A1
(43) Pub. Date: Apr. 23, 2015

(54) METHOD AND APPARATUS FOR PROCESSING INTERACTIVE SERVICE IN DIGITAL SIGNAGE SYSTEM

(71) Applicant: ELECTRONICS AND TELECOMMUNICATIONS RESEARCH INSTITUTE, DAEJEON-CITY (KR)

(72) Inventors: Sung-Hei KIM, Daejeon (KR); Wook HYUN, Daejeon (KR); Mi-Young HUH, Daejeon (KR); Shin-Gak KANG, Sejong (KR)

(21) Appl. No.: 14/513,817

(22) Filed: Oct. 14, 2014

(30) Foreign Application Priority Data
Oct. 23, 2013 (KR) 10-2013-0126599
Oct. 2, 2014 (KR) 10-2014-0133029

(51) Int. Cl. G06Q 30/02

(52) U.S. Cl. CPC G06Q 30/0269; G06Q 30/0264
USPC 705/14.61; 705/14.66

(57) ABSTRACT

A method and digital signage terminal for processing an interactive service using a digital signage system are disclosed. The digital signage terminal includes a device controller, a configuration manager, a device event receiver, an event data analyzer, and a registered event dispatcher. The device controller performs control so that the auxiliary device receives at least one event. The configuration manager receives a client configuration message, and extracts first event request information. The device event receiver receives raw data related to a first event. The event data analyzer converts the raw data into information related to the first event. The registered event dispatcher registers a second event based on the extracted first event request information, receives the information related to the first event, determines whether the first event corresponds to the registered second event, and generates determination information indicating that the first event corresponds to the second event.

### CROSS-REFERENCE TO RELATED APPLICATIONS

This application claims the benefit of Korean Patent Application Nos. 10-2013-0126599 and 10-2014-0133029, filed Oct. 23, 2013 and Oct. 2, 2014, respectively, which are hereby incorporated by reference herein in their entirety.

### BACKGROUND

1. Technical Field

The present disclosure relates to a method and apparatus for processing an interactive service in a digital signage system. More particularly, the present disclosure relates to technology for processing digital signage content between a digital signage terminal and a digital signage server.

2. Description of the Related Art

In general, digital signage (DS) systems are media play apparatuses that are used for marketing, advertising, etc. and that include a display panel. Digital signage systems are used by enterprises to play content designed to advertise their products or improve enterprise images because the digital signage systems can frequently and easily change content being displayed unlike advertising signboards. For these purposes, enterprises spontaneously install digital signage apparatuses in places having large floating populations.

Although various types of content and information can be provided through digital signage, infrastructures for digital signage are being currently used only for the purposes of simply performing unilateral marketing and advertising. Accordingly, a problem arises in that digital signage content unrelated to the users of digital signage terminals is played, and thus resources are unnecessarily wasted.

### SUMMARY

At least one embodiment of the present invention is directed to the provision of digital signage content suitable for a user using a digital signage system.

At least one embodiment of the present invention is directed to the provision of digital signage content suitable for the environment of a location where a digital signage terminal is placed using a digital signage system.

In accordance with an aspect of the present invention, there is provided a digital signage terminal for providing an interactive service using a digital signage system, the terminal including a device controller configured to control an auxiliary device so that the auxiliary device receives at least one event; a configuration manager configured to receive a client configuration message, used to process a specific event, from a digital signage server, and to extract first event request information from the client configuration message; a device event receiver configured to receive raw data related to a first event from the auxiliary device; an event data analyzer configured to convert the raw data into information related to the first event; and a registered event dispatcher configured to register a second event whose notification is requested based on the extracted first event request information, to receive the information related to the first event, to determine whether the first event corresponds to the registered second event, and to generate determination information indicating that the first event corresponds to the second event.

The event request information may include event requestor information that identifies a requestor including any one or more of the digital signage server having requested notification of occurrence of the second event, a digital signage content provider, and a play scheduler.

The registered event dispatcher may transfer the determination information to the requestor that is identified by the event requestor information.

The digital signage terminal may further include a play scheduler configured to receive a play schedule including information about playing of at least one piece of digital signage content; and a content processing unit configured to process playing of the at least one piece of digital signage content in accordance with the play schedule.

The play scheduler may extract second event request information from the play schedule, and may transmit the second event request information to the registered event dispatcher; and the registered event dispatcher may register a third event whose notification is requested based on the extracted second event request information, may determine whether the first event corresponds to the third event, may generate determination information indicating that the first event corresponds to the third event, and may transmit the determination information to the play scheduler.

The content processing unit may perform processing so that digital signage content related to the third event is played when the determination information is received.

The second event request information may include event-related content identification information that identifies digital signage content that is played when the third event occurs.

In accordance with another aspect of the present invention, there is provided a method of providing an interactive service using a digital signage system, the method including controlling an auxiliary device so that the auxiliary device receives at least one event; receiving a client configuration message, used to process a specific event, from a digital signage server, and extracting first event request information from the client configuration message; receiving raw data related to a first event from the auxiliary device; converting the raw data into information related to the first event; and registering a second event whose notification is requested based on the extracted first event request information, receiving the information related to the first event, determining whether the first event corresponds to the registered second event, and generating determination information indicating that the first event corresponds to the second event.

The event request information may include event requestor information that identifies a requestor including any one or more of the digital signage server having requested notification of occurrence of the second event, a digital signage content provider, and a play scheduler.

The method may further include transferring the determination information to the requestor that is identified by the event requestor information.

The method may further include receiving a play schedule including information about playing of at least one piece of digital signage content; and processing playing of the at least one piece of digital signage content in accordance with the play schedule.

The method may further include extracting second event request information from the play schedule; and registering a third event whose notification is requested based on the extracted second event request information, determining whether the first event corresponds to the third event, and generating determination information indicating that the first event corresponds to the third event.

Playing the at least one piece of digital signage content may include performing processing so that digital signage content related to the third event is played when the determination information is received.

The second event request information may include event-related content identification information that identifies digital signage content that is played when the third event occurs.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram of a digital signage system according to an embodiment of the present invention;

FIG. 2 is a diagram of a digital signage terminal according to an embodiment of the present invention;

FIG. 3 is a diagram of a method of registering an event according to an embodiment of the present invention;

FIG. 4 is a diagram of a method of releasing an event according to an embodiment of the present invention;

FIG. 5 is a diagram of a case where a plurality of events is input from a single piece of digital signage content according to an embodiment of the present invention;

FIG. 6 is a diagram of a case where digital signage content varies depending on event information according to an embodiment of the present invention;

FIG. 7 is a diagram of a method of processing the occurrence of an event according to an embodiment of the present invention;

FIG. 8 is a diagram of a method of registering and releasing an event in response to a change in a play schedule according to an embodiment of the present invention;

FIG. 9 is a diagram of a process in which the digital signage server processes an event in response to a change in a play schedule according to an embodiment of the present invention;

FIG. 10 is a diagram of a process in which the play scheduler processes an event in response to a change in a play schedule according to an embodiment of the present invention; and

FIG. 11 is a diagram of metadata that may be exchanged between the components of the digital signage system according to an embodiment of the present invention.

### DETAILED DESCRIPTION

While embodiments of the present invention will be described with reference to the accompanying drawings and the descriptions on the accompanying drawings, the present invention is not limited or restricted to these embodiments.

The terms used in the present specification are selected from currently widely used general terms while taking into consideration their functions in the present invention, but may have meanings varying depending on the intention or practice of those skilled in the art or the advent of new technology. Furthermore, in some cases, there may be terms that are selected by an applicant as desired, in which case their meanings are described in corresponding portions of the following description. Accordingly, the terms used in the present specification should be interpreted based on the substantial meanings of the terms and the overall context of the present specification, rather than the simple names of the terms.

In the following description of the present invention, the connection between a specific component and another component includes not only a direct connection between them but also an indirect connection between them via a third component.

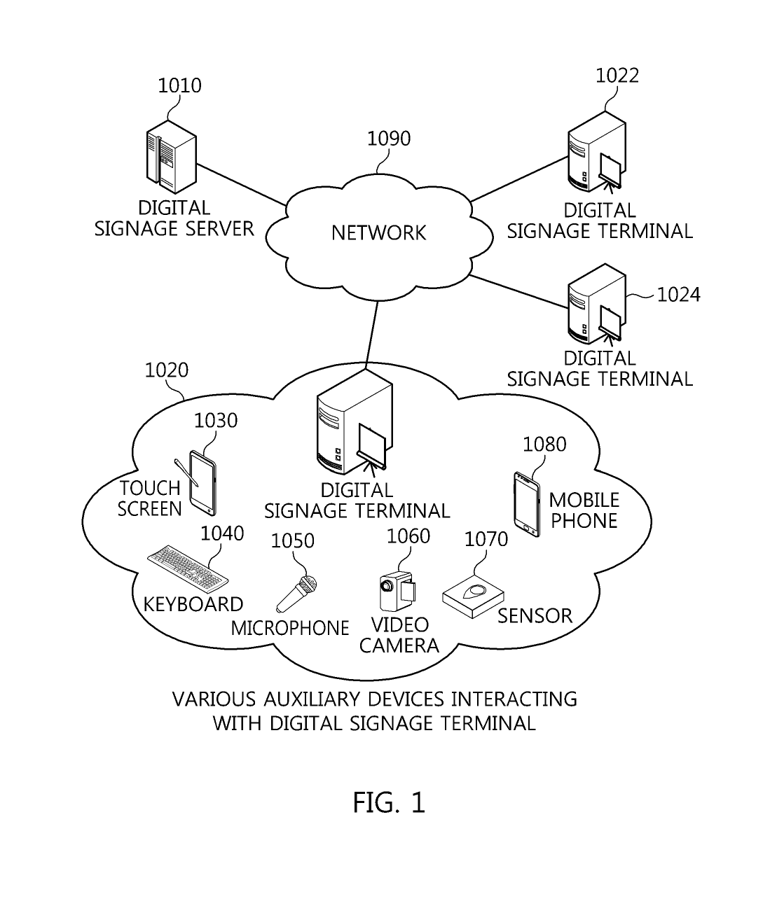

FIG. 1 is a diagram of a digital signage system according to an embodiment of the present invention.

The digital signage system according to the present embodiment may include a digital signage server 1010, digital signage terminals 1020, 1022 and 1024, a touch screen 1030, a keyboard 1040, a microphone 1050, a video camera 1060, a sensor 1070, a mobile phone 1080, and/or a network 1090.

The digital signage server 1010 may transmit an event or a message (content) to the digital signage terminals 1020, 1022 and 1024. In this case, the digital signage server 1010 may receive the event or message (content) from the outside, and may transfer the event or message (content) to the digital signage terminals 1020, 1022 and 1024. The digital signage server 1010 may receive various types of information from the digital signage terminals 1020, 1022 and 1024, and may process the information. The processed information may be transmitted to the outside, or may be transmitted back to the digital signage terminals 1020, 1022 and 1024.

That is, even information that has been generated or collected by the digital signage terminals 1020, 1022 and 1024 but does not have a format that can be finally used in the digital signage terminals 1020, 1022 and 1024 may be processed by the digital signage terminals 1020, 1022 and 1024 themselves. In this case, when the performance of the digital signage terminals 1020, 1022 and 1024 is not high or it is difficult to perform determination and processing within the terminals 1020, 1022 and 1024 themselves (for example, when user personal information, such as mobile phone information, a credit card information or the like, is processed), it may be possible to transfer the corresponding information to the digital signage server 1010, render the corresponding information into a format that can be finally used in the digital signage terminals 1020, 1022 and 1024 using the digital signage server 1010, and then transmit the rendered information to the digital signage terminals 1020, 1022 and 1024.

The digital signage terminals 1020, 1022 and 1024 function to process and display digital signage content (alternatively referred as content or an event). Each of the digital signage terminals 1020, 1022 and 1024 may be equipped with a device configured to process digital signage content. For example, each of the digital signage terminals 1020, 1022 and 1024 may include a display device (not illustrated) configured to display digital signage content, a processor (not illustrated) configured to process digital signage content-related data and/or information, a speaker (not illustrated) configured to play digital signage content-related audio, and/or a bidirectional communication interface (not illustrated) configured to perform bidirectional communication with the digital signage server 1010 or other digital signage terminals.

Furthermore, each of the digital signage terminals 1020, 1022 and 1024 may have various input devices, and digital signage content that is played by the digital signage terminal 1020, 1022 or 1024 may vary depending on content input via each of the input devices. Furthermore, the content of the input of each of the input devices may be information important to determine the surrounding environment of the corresponding digital signage terminal 1020, 1022 or 1024.

The input devices (auxiliary devices) may include the touch screen 1030, the keyboard 1040, the microphone 1050, the video camera 1060, the sensor 1070, and/or the mobile phone 1080.

The touch screen 1030 is a device that receives user input via a display panel. Digital signage content that is played by the digital signage terminal 1020, 1022 or 1024 is displayed on the display panel. User input may be received by the display panel by touching an input object, included in digital signage content or the On Screen Display (OSD) of the digital signage terminal 1020, 1022 or 1024 itself, via the touch screen 1030.

The keyboard 1040 may be included in the digital signage terminal 1020, 1022 or 1024 functioning as a kiosk or the like, and the keyboard 1040 may receive various types of input from a user.

The microphone 1050 receives the surrounding audio information of the user or digital signage terminal 1020, 1022 or 1024. A voice command received from the user via the microphone 1050 may be rendered into command information via the voice recognition function of the digital signage terminal 1020, 1022 or 1024. When the digital signage terminal 1020, 1022 or 1024 has no voice recognition function, a voice command may be transferred to the digital signage server 1010, may be rendered into command information recognizable by the digital signage terminal 1020, 1022 or 1024 by performing a voice recognition function in the digital signage server 1010, and may be transmitted to the digital signage terminal 1020, 1022 or 1024. The microphone 1050 may measure a noise level around the digital signage terminal 1020, 1022 or 1024, and then may control the sound level of the signage terminal 1020, 1022 or 1024. For example, when audio information is included in digital signage content, the noise level of audio collected via the microphone 1050 may be measured, and the volume of the audio of the digital signage content may be increased when the noise level is high, and the volume of the audio may be decreased when the noise level of the digital signage content.

The video camera 1060 may collect information about the user using the digital signage terminal 1020, 1022 or 1024 or information about various phenomena that may occur around the digital signage terminal 1020, 1022 or 1024. For example, information, such as the gender and body type of the user, popularity density, population, weather (rain, snow, or sunny), a road traffic condition, the pattern of the use of transportation means, and/or a human/vehicle direction, may be collected via the video camera 1060. As examples of service, in connection with weather, an advertisement for an umbrella or rainwear may be inserted when it rains, and an advertisement for a winter article, such as a coat, a hat or gloves, may be provided when it is cold. When a traffic condition is analyzed and it is determined that traffic congestion occurs, traffic may be distributed by indicating a detour or a vehicle may be assisted to be parked and wait for the release of traffic congestion in a neighboring parking lot by indicating the neighboring parking lot. Furthermore, when photos are collected using the video camera 1060 for each time span and various types of information (for each road condition, popularity density, gender, and body type) used to analyze a neighboring situation are extracted and transferred to a user behavior information collection client, the user behavior information collection client may utilize the situation information for the authoring of content in the future.

The sensor 1070 may include various types of sensing devices that receive various types of information. For example, the sensor 1070 may include a thermometer, a hygrometer, and/or an air pollution detector. The digital signage terminal 1020, 1022 or 1024 may play digital signage content based on information received via the sensor 1070. For example, cold beverage-centric advertisements are organized when the temperature is high, whereas hot tea-centric advertisements are organized when the temperature low. As another example, main news items are organized during rush hour for which traffic is heavy, and then a configuration may be made such that the digital signage terminal 1020, 1022 or 1024 waiting for a traffic signal can display digital signage content requiring relatively detailed information.

The mobile phone 1080 transfers user input to the digital signage terminal 1020, 1022 or 1024 via short/long range wireless communication. For example, when the digital signage terminal 1020, 1022 or 1024 functioning as a kiosk is used, the personal information of the user may be provided via the mobile phone 1080. In contrast, the digital signage terminal 1020, 1022 or 1024 may transmit digital signage content-related information or data to the mobile phone 1080.

When the digital signage terminal 1020, 1022 or 1024 is used in connection with the mobile phone 1080, functionality, such as payment, may be performed via the terminal that is carried by the user. Furthermore, the digital signage terminal 1020, 1022 or 1024 may provide required information to the user mobile phone 1080.

For example, a situation may occur in which a digital signage content-related questionnaire is present and the writer of the corresponding questionnaire is reluctant to fill out the questionnaire in a public place. In this case, a configuration may be made such that the digital signage terminal 1020, 1022 or 1024 transmits the corresponding questionnaire to the mobile phone of a user and the user fills out the questionnaire using the mobile phone and then returns the filled-out questionnaire to the digital signage terminal 1020, 1022 or 1024. In this case, the short/long-range wireless communication includes various wireless communication technologies (Bluetooth, NFC, WiFi, and/or WLAN). Furthermore, with regard to information by which the user should directly find a way, such as map information or shelter information, the content of the digital signage terminal 1020, 1022 or 1024 is synchronized with the content of the mobile phone 1080 and thus the user can directly view required content via his or her personal mobile phone.

The input devices that may be used by the digital signage terminal 1020, 1022 or 1024 are not limited to the above-described devices, but may also include future input devices that will appear in the future.

The network 1090 is responsible for bidirectional communication between the digital signage terminals 1020, 1022 and 1024 and the digital signage server 1010. The network 1090 may include a device that performs wired/wireless-type networking.

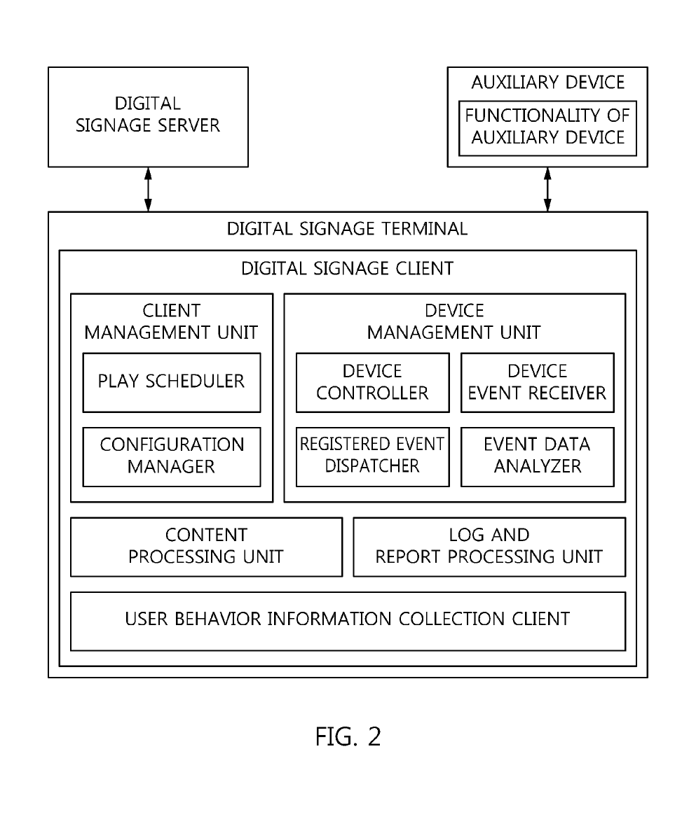

FIG. 2 is a diagram of a digital signage terminal according to an embodiment of the present invention.

Although the functions of a digital signage server are generally performed outside the digital signage terminal, the functions may be provided inside a specific digital signage terminal. Furthermore, an auxiliary device including an input device may be provided inside the digital signage terminal, and may be provided in a form that may be attached to the digital signage terminal from the outside of the digital signage terminal when required.

The digital signage server may directly control the auxiliary device of the digital signage terminal. The main control of the digital signage terminal may include the management of the power of the auxiliary device (power on/off), and/or the level of use of the auxiliary device. That is, when the digital signage server turns off a specific auxiliary device so that the specific auxiliary device cannot be used, the corresponding auxiliary device cannot be used in the corresponding digital signage terminal. Furthermore, when the digital signage server restricts the use of a specific auxiliary device, the other components of the digital signage terminal should use the corresponding auxiliary device in a limited form. For example, in an area where the use of a video camera is limited, the digital signage server cannot extract camera photo information, and is limited to the use of only information about the number of humans. Such a limitation or power control may be transmitted from the digital signage server to the digital signage terminal in her form of metadata or signaling information. When the digital signage terminal receives metadata or signaling information, the digital signage terminal performs the control or limitation indicated by the corresponding metadata or signaling information. In this case, a configuration should be made such that the digital signage terminal can interface with the auxiliary device.

The digital signage terminal may include a digital signage client and/or a user behavior information collection client.

The digital signage client may include a client management unit, a device management unit, a content processing unit, and/or a log and report processing unit.

The client management unit may include a play scheduler, and/or a configuration manager.

The play scheduler manages the play schedule of the digital signage content. The play scheduler receives a list related to a play schedule for signage content from the digital signage server, parses the list, and then plays the corresponding digital signage content based on times, situations, and/or placed presented by the list. In this case, each of the situations refers to a situation in which a configuration allows the digital signage content to be played. For example, when the temperature is equal to or higher than a predetermined temperature, an advertisement for cold beverage may be provided as the digital signage content. A reference for the temperature may be included in the play schedule-related list. That is, reference information for the situations of the playing of the digital signage content that has been described above or that will be described later may be included in the play list.

The configuration manager manages configurations applied to the digital signage terminal. For example, the configuration manager may make a configuration related to the playing of specific digital signage content of the digital signage terminal based on the play situation-related reference information included in the play schedule-related list. Alternatively, when information about the configuration of the digital signage terminal is transmitted from the digital signage server, the configuration manager may configure the digital signage terminal based on the corresponding information about the configuration. For example, when a predetermined function of the digital signage terminal should be restricted or stopped in a specific situation, the configuration manager may receive this configuration information from the digital signage server, and then may configure the digital signage terminal based on the received configuration information.

The device management unit may include a device controller, a device event receiver, a registered event dispatcher, and/or an event data analyzer.

The device controller may configure and control the power on/off of the auxiliary device or the detailed operations and functions of the auxiliary device.

The device event receiver receives data received from the auxiliary device. Since the received data has a raw data form, the device event receiver transfers the raw data to the event data analyzer in order to extract meaningful information. In this case, the raw data may generally include text, a voice, an image, a location and/or a numerical value.

The registered event dispatcher transfers related information to another component when the corresponding component registers event information or an event in which the corresponding component is interested occurs. The registered event dispatcher ignores an event in which no component is interested when receiving the event. That is, when information input via the auxiliary device or the like is related to a situation in which specific digital signage content is played, the play scheduler or the like is notified of the reception of the corresponding information.

The registered event dispatcher may manage auxiliary device information, event type information, interesting event information, and/or reception component information.

The registered event dispatcher registers or manages an event requested by another component of the digital signage system. The other component may request the registered event dispatcher to notify the other component of the occurrence of a specific event in a specific device (a specific digital signage terminal). This request may include a device ID and/or information descriptive of the event. The registered event dispatcher may notify the component of the occurrence of the specific event in the specific device.

The auxiliary device information includes information about an auxiliary device ID or the type of the auxiliary device.

The event type information includes a letter, a number, a sound, a video, X/Y coordinates, and/or an address that identifies the event.

The interesting event information includes a maximum/minimum range within which specific digital signage content can be played, a specific number, a specific type of sound, and/or a specific type of video.

The reception component information indicates a component that will receive the event.

The event data analyzer extracts meaningful information by interpreting and analyzing the received raw data. The event data analyzer transfers the extracted information to the registered event dispatcher. The event data analyzer may analyze various types of events, such as a touch event, a voice, a video, text, and/or a gesture.

The content processing unit performs a series of operations required to play digital signage content.

The log and report processing unit manages information about the checking of whether digital signage content has been played and a play record. The log and report processing unit stores the address of a server to which the information about the checking of whether digital signage content has been played and the play record should be reported, and transmits the information about the checking of whether digital signage content has been played and the play record to the corresponding address of the server. In this case, this server may be the digital signage server or a server being managed by a content provider.

The user behavior information collection client performs a series of operations related to audience measurement (AM). That is, the user behavior information collection client collects and reports information about a user who uses the digital signage terminal and who consumes the digital signage content.

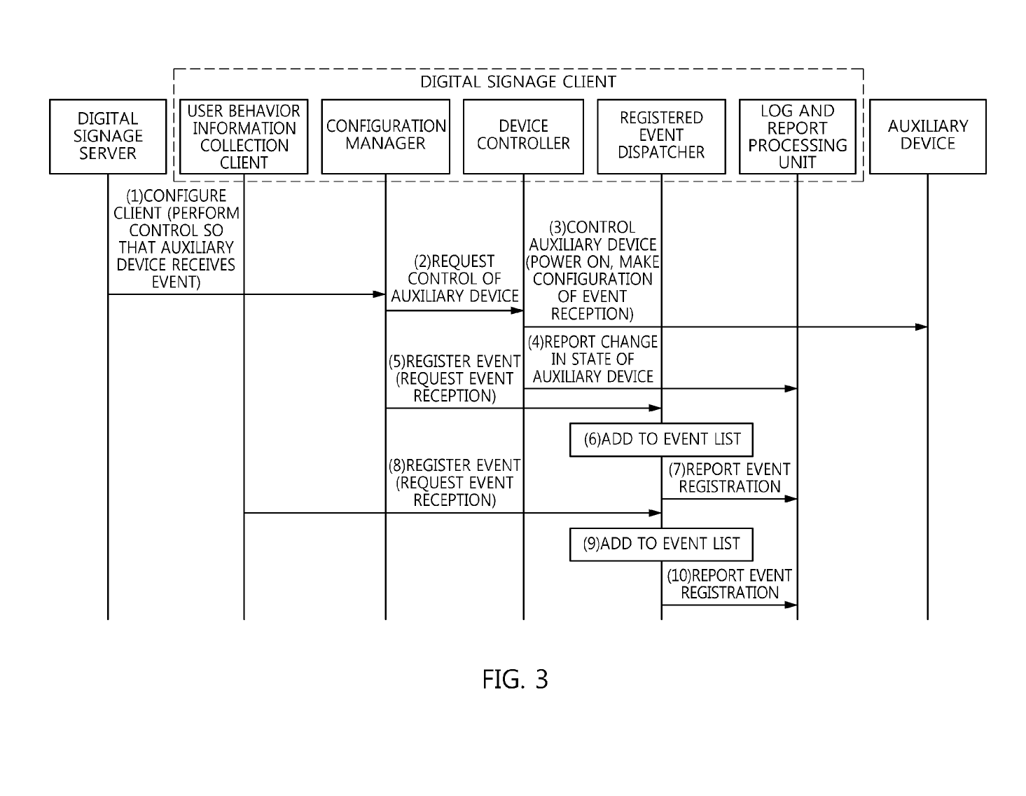

FIG. 3 is a diagram of a method of registering an event according to an embodiment of the present invention.

A client configuration message is received from the digital signage server at step 1. Alternatively, event request information adapted to receive a specific event is received from the digital signage server.

The client configuration message provides information required to configure the auxiliary device so that the auxiliary device can receive an event. The client configuration message may include control information and/or event request information.

The control information includes information required for the control or configuration of the auxiliary device or digital signage terminal. The event request information includes information required to request notification of the occurrence of a specific event when the specific event occurs in the auxiliary device or digital signage terminal.

The control information may include information related to the power on/off of the auxiliary device, black and white/color adjustment, and/or event information collection criteria.

The event request information may include auxiliary device identification information, event type information, event occurrence reference information, event requestor information and/or event request period information.

The auxiliary device identification information refers to an ID that uniquely identifies the auxiliary device.

The event type information identifies the type of event for which notification of occurrence is required. For example, the type of event may include text, audio, video, temperature and/or noise that are input to the digital signage terminal.

The event occurrence reference information identifies the extent of occurrence of an event for which notification of occurrence is required. For example, the event occurrence reference information may include a reference value that is used to request that notification be provided when specific text is input, when a temperature equal to or higher than a specific temperature is detected, or when noise equal to or higher than a specific volume is detected.

The event requestor information identifies a device, the digital signage server, an advertiser, and/or the play scheduler having requested notification of the occurrence of the event.

The event request period information identifies a period for which the notification of the occurrence of the event is required.

The client configuration message may include not only control information (information required for the control or configuration of the auxiliary device) but also information required for the overall configuration of components included in the digital signage client.

The configuration manager extracts control information from the client configuration message and then transfers the control information (auxiliary device control information) to the device controller at step 2. The configuration manager may extract event request information from the client configuration message, and then may transfer the event request information to the registered event dispatcher. Alternatively, if event request information is not included in the client configuration message, the configuration manager may generate the above-described event request information based on information included in the client configuration message, and then may transfer the above-described event request information to the registered event dispatcher.

The device controller configures the auxiliary device by directly controlling the auxiliary device in accordance with the control information at step 3. The auxiliary device transfers results in response to a configuration command from the device controller. For example, in the case of the error of the auxiliary device, a response indicating that a corresponding configuration cannot be performed is made, in which case the digital signage terminal may transmit an error state to the digital signage server.

The device controller reports changed state information to the log and report processing unit when the configuration state of the auxiliary device has been changed at step 4.

The configuration manager registers event request information in the registered event dispatcher when the digital signage client requires the reception of an event from a specific auxiliary device at step 5. For example, the digital signage client may request an event when it rains in order to present an advertisement for an umbrella in the case of heavy rain using a rain sensor. As another example, a child event may be requested in order to present an advertisement for a product in which a child is interested, such as a toy, in the case of the child passing by using a face recognition camera. As still another example, a configuration may be made such that the monitor of the digital signage terminal is turned off using a camera when there is no person in a space where the digital signage terminal has been installed. As still another example, a configuration may be made such that noise is measured using a microphone and then the sound level of the terminal is reduced in a quiet space and increased in a noisy space.

The registered event dispatcher registers an event requested by the configuration manager in the event list managed by itself at step 6.

The registered event dispatcher reports the occurrence of an event registration request to the log and report processing unit at step 7.

Another component, that is, the user behavior information collection client or the like, registers event request information in the registered event dispatcher at step 8. For example, the user behavior information collection client or digital signage server may request that the number of persons who are looking at the terminal squarely with interest be extracted using a camera and then transmitted. As another example, the user behavior information collection client or digital signage server may request that the number of persons who are looking at the terminal with interest be extracted for each category for children/adults/males/females/the old/the young using a camera and then transmitted. As still another example, the user behavior information collection client or digital signage server may request that the number of persons who have passed in front of the terminal be extracted for each time span using a camera and then transmitted. As still another example, the user behavior information collection client or digital signage server may request that information about temperature, humidity, or the like in front of terminal be provided for each time span using a sensor.

The registered event dispatcher registers an event requested by another component in the event list managed by itself at step 9.

The registered event dispatcher reports the occurrence of an event registration request to the log and report processing unit at step 10.

The digital signage server or user behavior information collection client may request information about a specific event using the above-described method, or may configure the digital signage terminal so that specific digital signage content can be played when a specific event occurs.

Each of the above-described steps may be omitted, or a step or an operation of a device described in another part of the present specification may be added to a specific part of the above-described process.

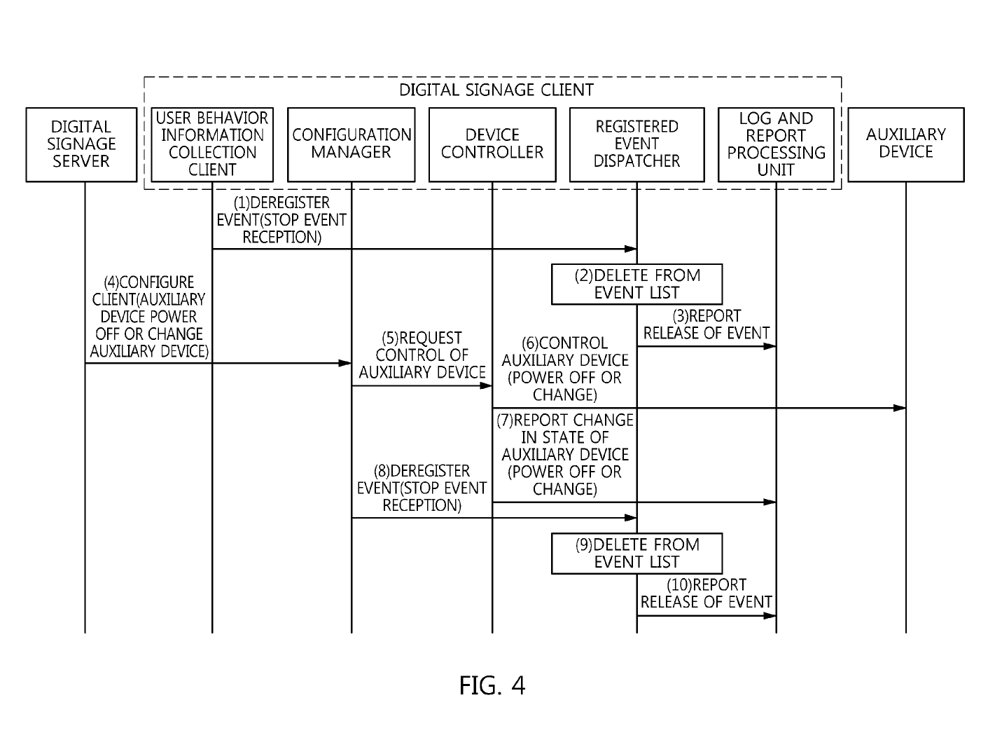

FIG. 4 is a diagram of a method of releasing an event according to an embodiment of the present invention.

The digital signage server or user behavior information collection client requests a stop to the reception of information about a corresponding event from the registered event dispatcher when the digital signage server or user behavior information collection client does not desire event-related information any more at step 1.

The registered event dispatcher deletes the corresponding event from the event list managed by itself at step 2.

The registered event dispatcher reports the occurrence of the event release request to the log and report processing unit at step 3.

The digital signage server may request a stop to the use of the auxiliary device that collects the corresponding event at step 4. Alternatively, the digital signage server may make a configuration so that the auxiliary device cannot receive the corresponding event.

The configuration manager transfers control information (auxiliary device control-related information) to the device controller at step 5

The device controller may change the state of the auxiliary device by directly controlling the auxiliary device at step 6.

The device controller reports state information to the log and report processing unit because the set state of the auxiliary device has been change at step 7.

The configuration manager requests the release of the event from the registered event dispatcher because it is impossible to receive the event from a specific auxiliary device at step 8.

The registered event dispatcher deletes the event requested by the configuration manager from the event list managed by itself at step 9.

The registered event dispatcher reports the occurrence of the event release request to the log and report processing unit at step 10.

Each of the above-described steps may be omitted, or a step or an operation of a device described in another part of the present specification may be added to a specific part of the above-described process.

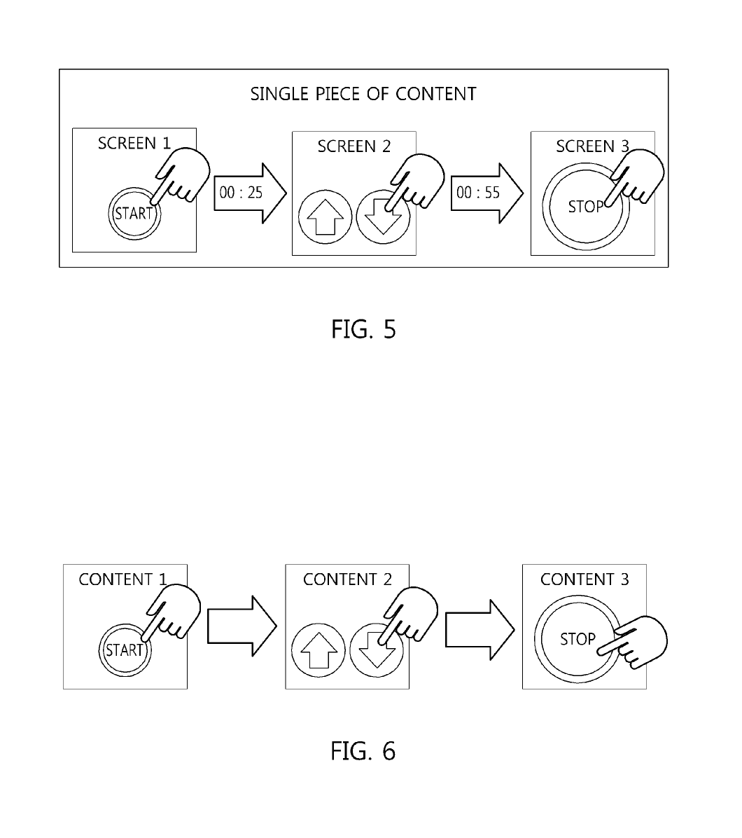

FIG. 5 is a diagram of a case where a plurality of events is input from a single piece of digital signage content according to an embodiment of the present invention.

The content of digital signage content to be played may vary depending on input event information (information collected by the auxiliary device).

As illustrated in FIG. 5, a single piece of digital signage content itself requests the input of event information, and the content of digital signage content varies in response to the corresponding event input. That is, when digital signage content itself is configured to display digital signage content in a plurality of directions, digital signage content may be varied using the method illustrated in FIG. 5 .

FIG. 6 is a diagram of a case where digital signage content varies depending on event information according to an embodiment of the present invention.

The digital signage terminal may selectively play a plurality of pieces of digital signage content depending on the situation. The situation in which specific digital signage content is played may be collected via event information.

For example, when the digital signage terminal displays a list of adjacent restaurants (tourist spots) and also the user selects a specific restaurant (tourist spot), the terminal may display a route map to the nearest restaurant (tourist spot) while playing an advertisement for the corresponding restaurant (tourist spot).

As another example, when a child appears while the digital signage terminal is playing a beer advertisement, the corresponding advertisement may be varied to a toy advertisement.

As still another example, a digital signage terminal that sells tickets at a bus stop is displaying an advertisement for an adjacent shop, and a language selection box is present on the upper right portion of a screen. When a person selects English in the language box, a variation may be made such that bus ticket purchase-related information is provided in English and also the advertisement for an adjacent shop is played in English.

As still another example, when digital signage content to be played is a winter coat advertisement but the temperature is above 30 degrees due to unusual weather, the winter coat advertisement may be varied to a cold beverage advertisement. An event by which an advertisement is restricted or started may be determined based on a prior agreement between a digital signage service provider and an advertiser. In this case, the advertiser may reduce advertising costs by preventing his or her advertisement from being exposed in a situation having a low effect, and may maximize an advertising effect by exposing his or her advertisement in a situation having a high effect.

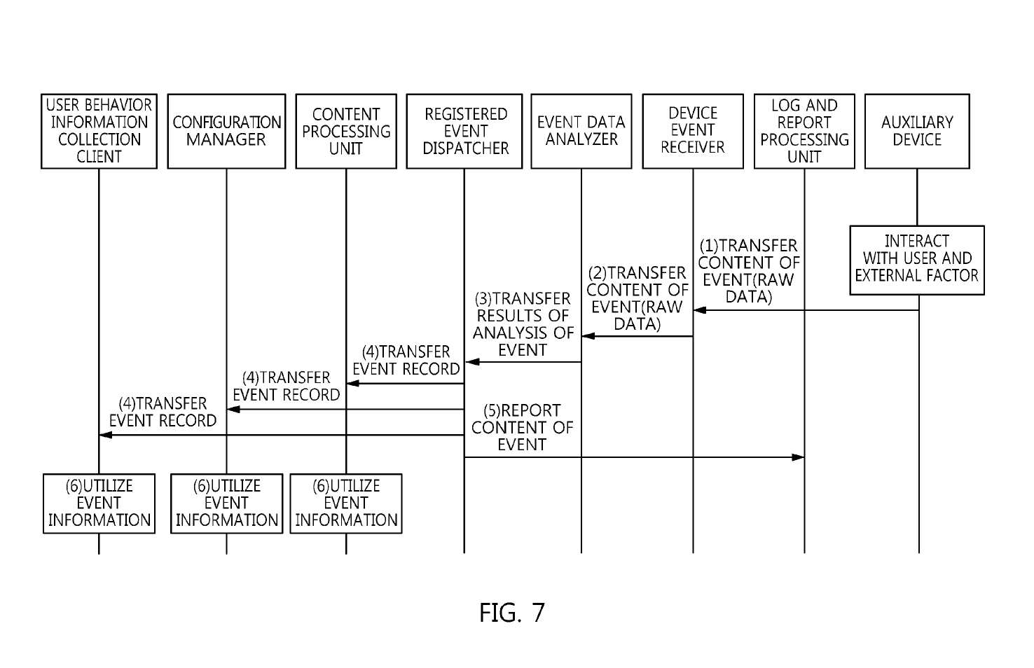

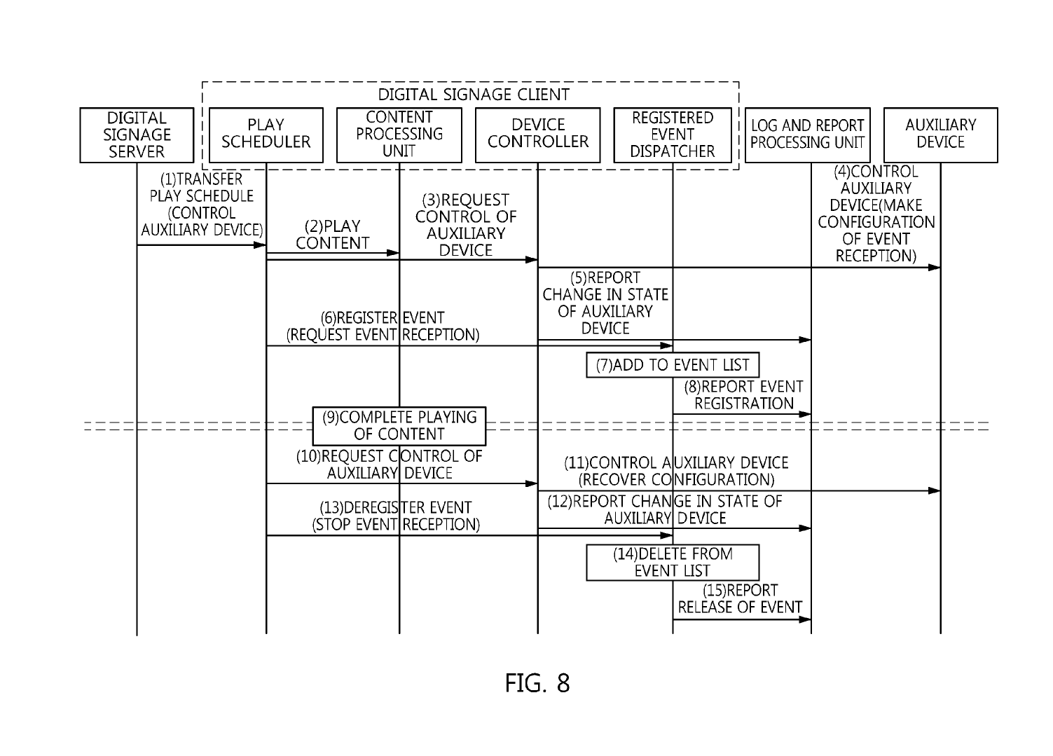

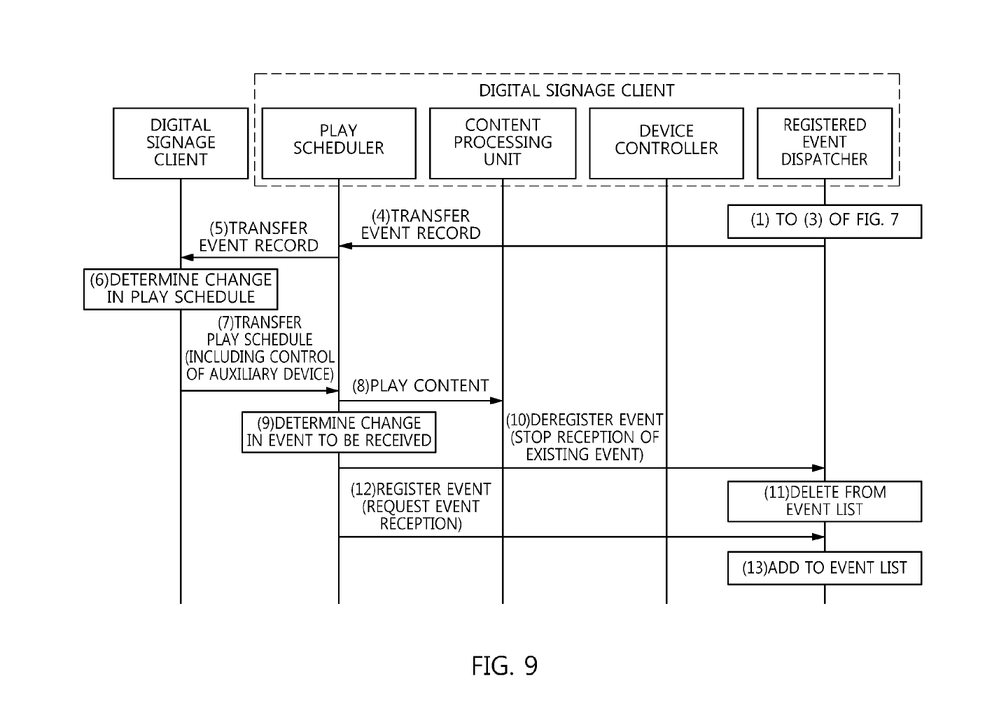

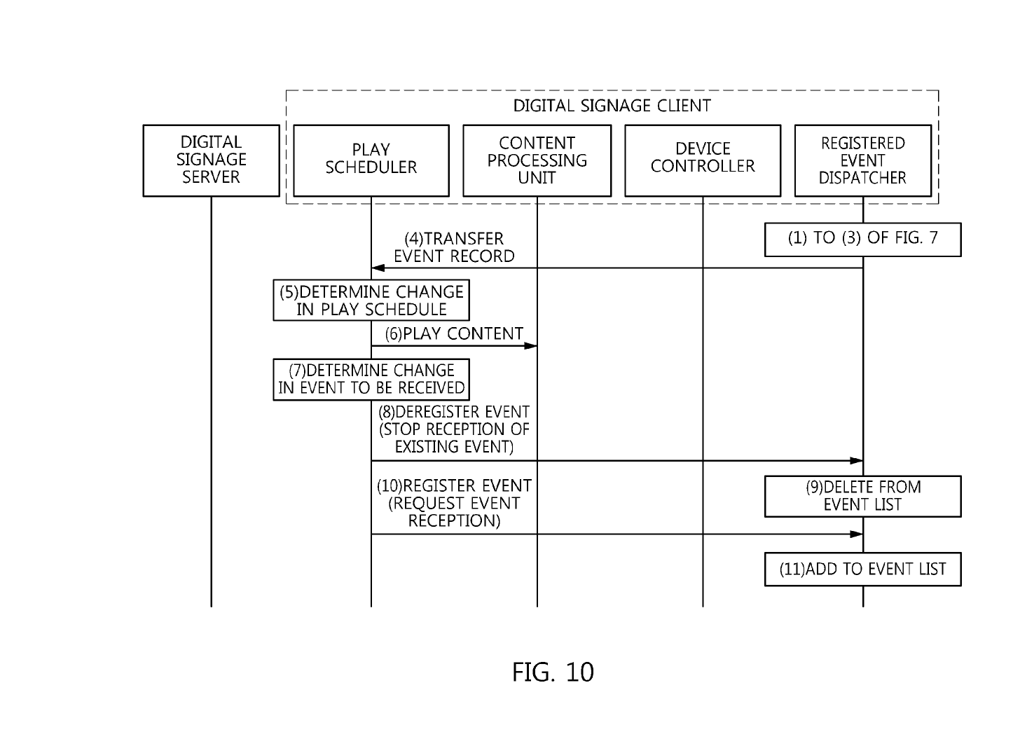

FIG. 7 is a diagram of a method of processing the occurrence of an event according to an embodiment of the present invention.

When the occurrence of event information attributable to the user and/or an external factor is received via the auxiliary device, the auxiliary device transfers the content of an event in a raw data form to the device event receiver at step 1. Generally, the auxiliary device may transfer raw data in a text, number, video, audio, screen coordinate, personal information, and/or sensing information form. The auxiliary device may include the type of raw data, a data reception time and/or an auxiliary device ID in a signal adapted to transfer the raw data, and then may transmit the signal.

At step 2, the device event receiver transfers the raw data to the event data analyzer capable of interpreting the raw data transferred by the auxiliary device and then extracting meaningful information.

At step 3, the event data analyzer transfers the interpreted information to the registered event dispatcher.

At step 4, the registered event dispatcher determines whether there is a component (an external or internal device) that is interested in the occurred event by searching the event management list, and then transfers the received event information to a corresponding component. The registered event dispatcher ignores the corresponding event if there is no component that is interested in the corresponding event.

At step 5, the registered event dispatcher transfers event-related information to the log and report processing unit so that the information is recorded in a log.

At step 6, the component that has received the event information utilizes the event information.

Each of the above-described steps may be omitted, or a step or an operation of a device described in another part of the present specification may be added to a specific part of the above-described process.

FIG. 8 is a diagram of a method of registering and releasing an event in response to a change in a play schedule according to an embodiment of the present invention.

At step 1, the digital signage server transfers a play schedule, including information about content to be played to the digital signage client, to the play scheduler.

The play schedule may include the above-described client configuration message. That is, the play schedule may include control information required for the control or configuration of the auxiliary device and/or event request information. In this case, the play schedule may include information descriptive of an event that is a condition under which specific content can be played. For example, the play schedule may include event-related terminal identification information, event-related content identification information, and/or current content handling information.

The event-related terminal identification information identifies the digital signage terminal that should play the specific content when the event consistent with the above-described event request information occurs.

The event-related content identification information identifies the content that should be played when the event consistent with the above-described event request information occurs.

The current content handling information identifies a method of processing content being currently played when the event consistent with the above-described event request information occurs and thus new content should be played. For example, the current content handling information may indicate the complete termination of the playing of current content, a pause to the playing of current content during the playing of event-related content, or the resumption of the playing of current content from the beginning upon the termination of the playing of event-related content depending on its value.

The play scheduler requests the content processing unit to play content in accordance with the play schedule at step 2.

Furthermore, prior to the playing of the content, the play scheduler may become aware that an event from a specific auxiliary device is required and request the use of the corresponding auxiliary device from the device controller at step 3.

If the corresponding auxiliary device cannot provide the event requested by the play scheduler, the device controller controls the auxiliary device so that the corresponding event can be received at step 4.

When the state of the auxiliary device has been changed, the device controller provides related information to the log and report processing unit at step 5. When the auxiliary device can provide an already requested event, steps 4 and 5 may be omitted.

The play scheduler may request the reception of an interesting event from the registered event dispatcher at step 6. In this case, the play scheduler may transmit the above-described event request information to the registered event dispatcher.

The registered event dispatcher registers the event requested by the play scheduler in the event list managed by itself at step 7. The registered event dispatcher registers the event requiring notification based on the received event request information.

The registered event dispatcher reports the occurrence of the event registration request to the log and report processing unit at step 8.

The content processing unit performs a series of processing required for the playing of the content at step 9.

If the event requested by the content does not occur at the content playing step, the processing of the event is terminated in accordance with the following process staring from step 10. In contrast, if the event requested by the content occurs, processing may be performed in accordance with the process of FIG. 9, which will be described below.

If the registered event occurs at the content playing step, the play scheduler requests the content processing unit to play content in accordance with a corresponding event-related play schedule. In this case, content being currently played may be processed in accordance with the above-described current content handling information.

In some cases, if the registered event occurs at the content playing step, the play scheduler may request a new play schedule from the digital signage server. In this case, the play scheduler requests the content processing unit to play content in accordance with the new play schedule.

Once the playing of the content has been completed, the play scheduler may request the auxiliary device to change the state of the auxiliary device as required because the play scheduler does not require the corresponding event at step 10.

If the device controller becomes aware that another component does not require the corresponding auxiliary device, the device controller performs control so that the state of the auxiliary device is changed at step 11, and reports the change in the state of the auxiliary device to the log and report processing unit at step 12. If the auxiliary device needs to be maintained even after the completion of the playing of the content, steps 11 and 12 may be omitted.

At step 13, the play scheduler notifies the registered event dispatcher that the play scheduler will stop the reception of the event.

The registered event dispatcher deletes the corresponding event from the event list at step 14.

At step 15, the registered event dispatcher notifies the log and report processing unit that the event has been released.

Each of the above-described steps may be omitted, or a step or an operation of a device described in another part of the present specification may be added to a specific part of the above-described process.

FIG. 9 is a diagram of a process in which the digital signage server processes an event in response to a change in a play schedule according to an embodiment of the present invention.

At steps 1 to 3, the registered event dispatcher receives interpreted information via steps 1 to 3 of FIG. 7.

At step 4, the registered event dispatcher determines that the play scheduler is interested in an occurred event by searching the event management list, and then transfers the received information.

The play scheduler determines whether the event is an event that can be processed by itself or an event that should be transferred to the digital signage server by analyzing the content of the event. When the digital signage server has provided notification of a subsequent process based on the event, processing may be performed in accordance with the subsequent process. Otherwise the play scheduler inquires of the digital signage server about the subsequent process at step 5. In particular, if the client has no capability to make determination or there is no information or content required for the performance of the subsequent process, a direction from the digital signage server should be waited for. Since a problem, such as the theft of the terminal, may occur when personal information is stored in the client, a method of maintaining and processing such information in the server, rather than maintaining the information in the terminal, may be chosen. In this case, the digital signage terminal transfers event information to the digital signage server.

At step 6, the digital signage server becomes aware of a need for a new play schedule, and then reconfigures a play schedule.

The digital signage server transfers the play schedule to the play scheduler of the client at step 7. In this case, the digital signage server may also transfer the control information of the auxiliary device.

The play scheduler transfers information about content, to be subsequently played in accordance with the newly received play schedule, to the content processing unit at step 8.

In this case, the play scheduler checks the newly received play schedule for whether the event to be received has been changed at step 9.

At step 10, the play scheduler determines that an existing event is not required, and requests a stop to the reception of the event from the registered event dispatcher in order to stop the reception of the existing event.

When receiving the stop request, the registered event dispatcher deletes the event from the event list at step 11.

At step 12, the play scheduler determines that there is a new event to be received, and requests the reception of an event from the registered event dispatcher in order to receive the new event.

At step 13, the registered event dispatcher adds the event whose reception has been requested to the list.

Each of the above-described steps may be omitted, or a step or an operation of a device described in another part of the present specification may be added to a specific part of the above-described process.

FIG. 10 is a diagram of a process in which the play scheduler processes an event in response to a change in a play schedule according to an embodiment of the present invention.

At steps 1 to 3, the registered event dispatcher receives interpreted information via steps 1 to 3 of FIG. 7.

At step 4, the registered event dispatcher determines that the play scheduler is interested in an occurred event by searching the event management list, and then transfers the received information.

Since the play scheduler includes information required by the client, the play scheduler itself constructs a new play schedule at step 5.

The play scheduler transfers content to be subsequently played to the content processing unit at step 6.

In this case, the play scheduler checks the newly received play schedule for whether the event to be received has been changed at step 7.

At step 8, the play scheduler determines that an existing event is not required, and then requests a stop to the reception of the event from the registered event dispatcher in order to stop the reception of the existing event.

When receiving the stop request, the registered event dispatcher deletes the event from the event list at step 9.

At step 8, the play scheduler determines that there is a new event to be received, and requests the reception of an event from the registered event dispatcher in order to receive the new event.

The registered event dispatcher adds the event whose reception has been requested to the list at step 11.

Each of the above-described steps may be omitted, or a step or an operation of a device described in another part of the present specification may be added to a specific part of the above-described process.

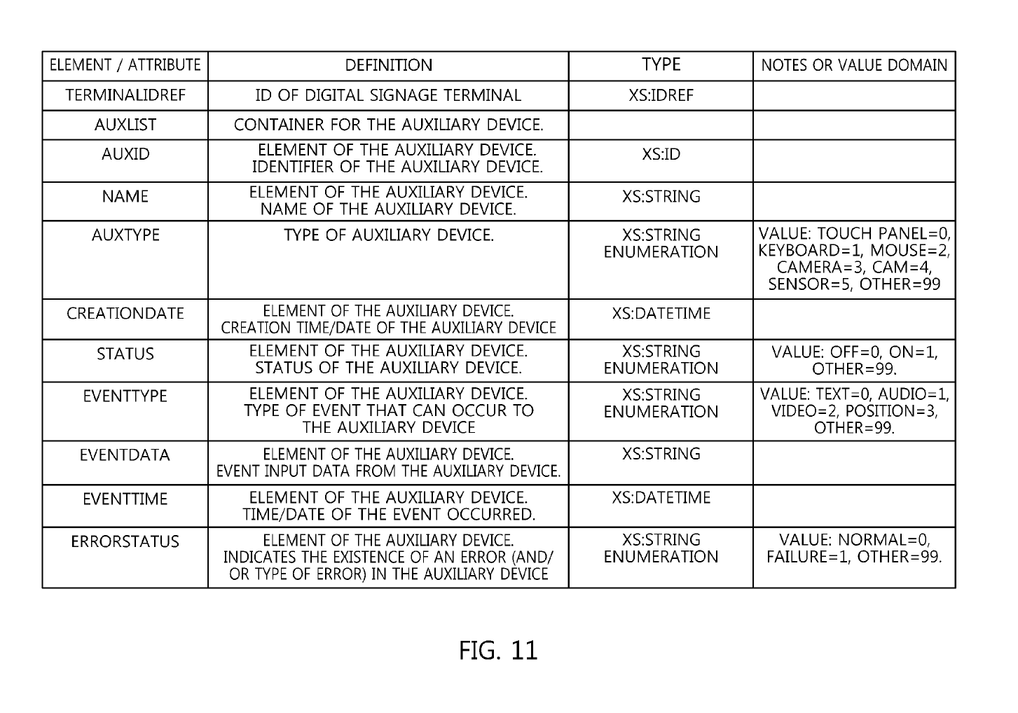

FIG. 11 is a diagram of metadata that may be exchanged between the components of the digital signage system according to an embodiment of the present invention.

The metadata that may be exchanged between the components of the digital signage system according to the present embodiment may include a TerminalldRef element, an AuxList element, an Auxld element, a Name element, an AuxType element, a CreationDate element, a Status element, an EventType element, an EventData element, an EventTime element, and/or an ErrorStatus element.

The TerminalldRef element represents the identifier (ID) of a digital signage terminal. The TerminalldRef element functions to identify a digital signage terminal that consults corresponding metadata.

The AuxList element represents a list of auxiliary devices. The AuxList element includes information about auxiliary devices that can be used in a digital signage terminal.

The Auxld element represents the ID of an auxiliary device. The Auxld element is information that identifies each of the auxiliary devices included in the list of auxiliary devices.

The Name element represents the name of an auxiliary device.

The AuxType element identifies the type of auxiliary device. The AuxType element identifies an auxiliary device as a touch panel, a keyboard, a mouse, a camera, a video camera, a sensor or an undefined device based on its value.

The CreationDate element represents the time and/or date when an auxiliary device has been generated. Alternatively, the CreationDate element represents the generation time and/or date when information generated by an auxiliary device has been generated. Alternatively, the CreationDate element may indicate the time and/or date when an auxiliary device operates effectively.

The Status element represents the state of an auxiliary device. The Status element indicates that an auxiliary device is in an on state, an off state or another state based on its value.

The EventType element type represents the type of event that occurs in an auxiliary device. Alternatively, the EventType element may represent the type of input information that is generated in an auxiliary device. The EventType element may indicate that an event occurring in an auxiliary device is text, audio, a location or another type of information based on its value.

The EventData element includes information about an event that is input from an auxiliary device.

The EventTime element represents the time and/or date when an event has occurred.

The ErrorStatus element represents whether an error has occurred in an auxiliary device. The ErrorStatus element may identify the type of error that has occurred in an auxiliary device.

At least one embodiment of the present invention achieves an advantage of being able to provide user customized content using a digital signage terminal.

At least one embodiment of the present invention achieves an advantage of being able to provide content varying depending on a change in an environment using a digital signage terminal.

At least one embodiment of the present invention achieves an advantage of being able to effectively control individual components included in a digital signage system.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A digital signage terminal for providing an interactive service using a digital signage system, the terminal comprising:
a device controller configured to control an auxiliary device so that the auxiliary device receives at least one event;
a configuration manager configured to receive a client configuration message, used to process a specific event, from a digital signage server, and to extract first event request information from the client configuration message;
a device event receiver configured to receive raw data related to a first event from the auxiliary device;
an event data analyzer configured to convert the raw data into information related to the first event; and
a registered event dispatcher configured to register a second event whose notification is requested based on the extracted first event request information, to receive the information related to the first event, to determine whether the first event corresponds to the registered second event, and to generate determination information indicating that the first event corresponds to the second event.

2. The digital signage terminal of claim 1, wherein the event request information comprises event requestor information that identifies a requestor including any one or more of the digital signage server having requested notification of occurrence of the second event, a digital signage content provider, and a play scheduler.

3. The digital signage terminal of claim 2, wherein the registered event dispatcher transfers the determination information to the requestor that is identified by the event requestor information.

4. The digital signage terminal of claim 1, further comprising:
a play scheduler configured to receive a play schedule including information about playing of at least one piece of digital signage content; and
a content processing unit configured to process playing of the at least one piece of digital signage content in accordance with the play schedule.

5. The digital signage terminal of claim 4, wherein:
the play scheduler extracts second event request information from the play schedule and transmits the second event request information to the registered event dispatcher; and
the registered event dispatcher registers a third event whose notification is requested based on the extracted second event request information, determines whether the first event corresponds to the third event, generates determination information indicating that the first event corresponds to the third event, and transmits the determination information to the play scheduler.

6. The digital signage terminal of claim 5, wherein the content processing unit performs processing so that digital signage content related to the third event is played when the determination information is received.

7. The digital signage terminal of claim 6, wherein the second event request information comprises event-related content identification information that identifies digital signage content that is played when the third event occurs.

8. A method of providing an interactive service using a digital signage system, the method comprising:
controlling an auxiliary device so that the auxiliary device receives at least one event;
receiving a client configuration message, used to process a specific event, from a digital signage server, and extracting first event request information from the client configuration message;
receiving raw data related to a first event from the auxiliary device;
converting the raw data into information related to the first event; and
registering a second event whose notification is requested based on the extracted first event request information, receiving the information related to the first event, determining whether the first event corresponds to the registered second event, and generating determination information indicating that the first event corresponds to the second event.

9. The method of claim 8, wherein the event request information comprises event requestor information that identifies a requestor including any one or more of the digital signage server having requested notification of occurrence of the second event, a digital signage content provider, and a play scheduler.

10. The method of claim 9, further comprising transferring the determination information to the requestor that is identified by the event requestor information.

11. The method of claim 8, further comprising:
receiving a play schedule including information about playing of at least one piece of digital signage content; and
processing playing of the at least one piece of digital signage content in accordance with the play schedule.

12. The method of claim 11, further comprising:
extracting second event request information from the play schedule; and
registering a third event whose notification is requested based on the extracted second event request information, determining whether the first event corresponds to the third event, and generating determination information indicating that the first event corresponds to the third event.

13. The method of claim 12, wherein playing the at least one piece of digital signage content comprises performing processing so that digital signage content related to the third event is played when the determination information is received.

14. The method of claim 13, wherein the second event request information comprises event-related content identification information that identifies digital signage content that is played when the third event occurs.
